(19) United States
(12) Patent Application Publication
(10) Pub. No.: US 2017/0203974 A1
(43) Pub. Date: Jul. 20, 2017

(54) CHEMICAL MANAGEMENT FOR SWIMMING POOLS

(71) Applicant: EFFICIENCY FILTERS PTY LTD, Northbridge, New South Wales (AU)

(72) Inventors: John RIEDL, New South Wales (AU); John MORGAN, New South Wales (AU); Greg IRVING, New South Wales (AU)

(21) Appl. No.: 15/314,416

(22) PCT Filed: May 27, 2015
(86) PCT No.: PCT/AU2015/050285

§ 371 Date: Nov. 28, 2016

(30) Foreign Application Priority Data
May 27, 2014 (AU) 2014902004

(51) Int. Cl. C02F 1/00; C02F 1/467; C02F 1/66; C02F 1/461; G05D 21/02; E04H 4/12

(52) U.S. Cl. CPC C02F 1/008; G05D 21/02; E04H 4/1245; C02F 1/66; C02F 1/4618; C02F 1/4674; C02F 1/46109; C02F 2103/42

(57) ABSTRACT

A system for electric pH control of saltwater swimming pools, including a pump-assisted circuit for circulating saltwater to and from a swimming pool, means for determining the pH of the saltwater, a pH control cell having at least one pair of electrodes arranges: for electrolytically creating an alkaline and an acidic chemical, the cell including a water flow-through compartment and a species separation compartment, the compartments being separated by a separator structure, a drainage structure, and a controller functionally operative to compare the pH determined or sensed with a desired pH value, apply an electric potential across the electrodes of the cell and control one or both of the potential and electric current supplied to the electrodes as a function of the pH comparison and regulate drainage of an alkaline or acidic species which has been electrolytically generated.

### CROSS REFERENCE TO RELATED APPLICATIONS

This application the National Stage of International Application No. PCT/AU2015/050285 having an International Filing date of 27 May 2015, which designated the United States of America, and which. International Application was published under PCT Article 21(2) as WO Publication No. 2015/179919 A1, and which claims priority from, and the benefit of, Australian Application No. 2014902004, filed on 27 May 2014, the disclosures of which are incorporated herein by reference in their entireties.

### BACKGROUND

1. Field

The presently closed embodiment relates primarily to the control of in swimming pools, and also to a means of saltwater chlorination of swimming pools.

2. Brief Description of Related Developments

Swimming pools are mostly sanitized by the use of chlorine. The chlorine may be added to the pool in many ways, including chlorine bearing compounds in solid form, liquids (usually as sodium hypochlorite or bleach, in solution), or as a gas (typical as chlorine or chlorine dioxide); in over 85% of Australian residential swimming pools, chlorination is effected by electrolysis of pool water to which a salt has been added, i.e. salt water chlorination.

Saltwater chlorination is a process that uses a salt, usually NaCl but could be other chloride or bromide salts, dissolved in pool water at typically 2,500 to 6,000 parts per million (ppm), as a source of chlorine (or bromine) in generating sanitizing chlorine (or bromine) compounds, in particular the preferred hypochlorous acid (HClO).

The term ‘saltwater’ is used in the present document to denote pool water with a typical load of salt (which need not be but preferably in its bulk amount is NaCl) in the range of 3,000-6,000 ppm, but could range from 500-1,000 ppm to seawater salt concentrations in practice, as source of the disinfectant halide entity (usually Cl, Br). Further, the aspects of the presently disclosed embodiment will be described in the context of use of chlorine as the halide, but it will be understood that other compounds are and may be used.

To effect saltwater chlorination, ‘salted’ pool water is pumped through an electrolytic chlorine generator (or cell) comprising at least one anode-cathode plate set. Usually, titanium is used for the electrodes, at times the plates are coated with a metal oxide such as that of ruthenium, or iridium. Other plate materials (such as carbon, graphite or platinum) and other coatings and/or doped materials are also used. Perforated plates (and coaxial mesh cylinders) may also be used rather than parallel solid plates.

Irrespective of the precise details of plate materials, number of plates and geometry, when a voltage (i.e. a potential difference), usually in the 2 volt to 8 volt range, is applied between the electrodes, electrolysis of salt water will lead to water being dissociated generating hydrogen gas at one electrode (cathode), and chlorine at the other electrode (anode). The otherwise flammable and potentially explosive hydrogen gas generated at the cathode is safely flushed from the cell in the water stream passing through it, noting that conventional salt water chlorine generators are usually installed in line after the swimming pool filter as the last item in the recirculation line towards the swimming pool.

Chlorine is produced at the anode of the chlorinator according to the reaction

2Cl⁻→Cl₂+2 e⁻ (1)

The chlorine reacts rapidly with water according the reaction

Cl₂+H₂O→HCl+HClO (2)

The hydrochloric acid is fully dissociated. The hypochlorous acid is in equilibrium with its conjugate base, the hypochlorite ion, according the equation

HClO⇄H⁺+OCl⁻ (3)

the cathode the main reaction

2H₂O+2 e⁻→H₂+2OH⁻ (4)

For the purposes of sanitation, these re the main reactions occurring in saltwater chlorination, though many other reactions also occur depending on the chemical composition of the pool water, potential difference, configuration of the chlorinator plates, and other variables.

Hypochlorous acid is a much stronger disinfectant than the hypochlorite ion, and is the principal and preferred disinfecting agent.

Relevantly, the concentrations of hypochlorous acid and hypochlorite ion, which are the chlorine hydrolysis compounds, are controlled by pH according to the above equilibrium (equation3), and so the sanitizing effectiveness of chlorination varies considerably with the pH of the water, which also affects comfort of users of the swimming pool.

Put in another way, disinfection of pool water is much more effective at lower pH values because the chlorine hydrolysis products are mostly present in the form of highly disinfectant hypochlorous acid rather than the mild disinfectant hypochlorite ion. The desired pH range for swimming pools, considering these and other factors such as the longevity and the appearance of the finish on the poor's structural surface, ought thus typically to be set at 6.9 to 7.8, but in Australia more commonly at 7.2 to 7.6.

It can be seen further from the equations above that for every two moles of strongly basic (alkaline) hydroxide ion produced at the cathode, the anode produces one mole of a strong acid (HCl) and one mole of weak acid (HClO). When mixed together as in the output stream of conventional saltwater chlorinators, the acid compounds (herein also referred to as acidic chemical species) may completely or incompletely neutralize the alkaline compounds (herein also referred to as alkali chemical species), depending on the pH and the degree of dissociation of the hypochlorous acid. So, the overall chlorination process either does not change the pH or it increases the pH; it does not decrease the pH of the chlorinated pool water. Optimising the pH setting must therefore be done using other techniques, as noted below.

Another factor to consider is that most in ground pool shells are made of concrete or have surface finishes that incorporate cement, both of which are alkaline and which tend to leach alkali into the pool water.

Consequently, the combination of such leaching and the electrolytic chlorination process tend to drive the pool alkaline with time, that is, to higher pH values. Even pools made of more neutral materials such as fibreglass may naturally drift to higher pH values due to the effects of the electrolytic process which, overall, tends to be alkaline.

This tendency to high pH in swimming pools is typically countered in conventional pool set-ups by adding hydrochloric acid (in addition to that created in the chlorinator), in amounts as required to maintain the pH within the desired range. Other acids can also be used and bubbling carbon dioxide into pool water to form carbonic acid is one such other method. Concentrated hydrochloric acid, also known as muriatic acid, is most widely used.

The use of concentrated hydrochloric acid usually means the storage of significant quantities of this dangerous substance in domestic situations, often without the precautions and due care that are appropriate. Dispensing is done either by manual methods, which require careful measurement and handling, or in automated acid dispensing systems; or by pumps or other mechanical dispensing methods to deliver metered amounts of acid. Such mechanised dispensing methods can be automated using sensors, or semi-automated (pre-set to a daily quantity dispensed).

Both methods have significant problems. Manual methods are notoriously inaccurate and unreliable and, in typical domestic situations, are seldom performed regularly and very rarely performed often enough to achieve effective control of pH. Weeks and sometimes months pass between treatments when, in reality daily or every second-day treatment is required in some pools to ensure good or even acceptable sanitizer performance. In addition, manual handling of acid is undesirable for safety reasons.

In automatic systems and semi-automatic systems, peristaltic pumps are usually used, which are notoriously unreliable and break down, resulting in ineffective pH control and sanitation in the pool and drums of unused acid left deteriorating on-site for long periods. In short, residential sites are seldom managed correctly for a variety of reasons.

As noted above, overall, most in-ground pools tend to drift to being alkaline over time, and the most common pool, being the concrete one with a cement-based finish, strongly so to the extent that many litres of acid a year may be required to balance the water. This is especially true of new pools where leaching rates and alkalinity are much higher a old pools that are more chemically stable.

On the other hand, although more rare, some pools can become acidic. In this case, an alkali needs to be added to restore pH to the desirable range. This is often sodium bicarbonate. This chemical is also very commonly dissolved in the pool water as a buffer to stop the pool going acid and reduce the rate of change of pH.

Electrolytic systems for the automatic control of chlorine content and pH in swimming pools have been proposed, such as in U.S. Pat. No. 4,767,511 (Aragon). The system described by Aragon uses a dual-compartment electrolytic cell for generation of chlorine and caustic soda (NaOH) from a sodium chloride solution (brine) and water, as well as an acid supply system for adding hydrochloric acid directly to the pool water as required for pH control. Generation of chlorine and addition of HCl are controlled automatically in response to sensed oxidation-reduction potential (ORP) and pH in the swimming pool water. The dual-compartment electrolytic cell has a porous diaphragm (or separator) dividing the cell into anolyte and catholyte compartments. Chlorine gas generated in the analyte compartment of the cell is separated from spent brine which is recirculated back into the NaCl+H2O (brine) supply tank where is re-saturated, whereas caustic soda, H2 gas and water are supplied from the catholyte compartment of the cell into the pool water return line of the cell.

The system of Aragon requires a dedicated brine supply tank (storage) and recirculation circuit between tank and electrolytic cell, as well as a separate HCl storage facility and supply line to pool, to effect both the pH and chlorination control.

The presently disclosed embodiment seeks to provide an electric pH control system, using electrolysis of saltwater, which is preferably automated, and without the need for bulk acid addition to the swimming pool water.

It would be beneficial too to define an electric control cell which could be used simultaneously as a chlorinator cell.

It would be beneficial also for the system to enable a reduction of regular bulk material inputs into the pool water, i.e. consumables, in particular acids such as HCl.

It is also desired to simplify the make up of a pH and chlorination control system which is effective in maintaining effective pool water sanitation levels.

It would also be desirable to devise an electrolytic pH control cell in which build-up of scale on the electrodes (and other metallic components of the cell) can be minimised or cleaned-up in operation of the cell.

### SUMMARY

In the different aspects of the presently disclosed embodiment, swimming pool saltwater is subjected to hydrolysis, whereby chlorine is generated in a fairly conventional manner. Relevantly, however, the inventive lay out of the electrolytic cell is such that the pH of the saltwater exiting the cell is controlled by selective removal of chemical alkaline species, created in the electrolysis process, from the stream of water flowing through the cell. This process renders the saltwater more acidic prior to being delivered from the cell into the swimming pool, reducing the pH. Furthermore, the below described inventive cell can also be operated in a manner to selectively remove chemical acidic species, thereby increasing the pool pH where such is necessary, preferably by temporary inversion of the polarity applied to the cell's electrodes.

In a first aspect of the presently disclosed embodiment, there is provided a system for electric pH control of saltwater swimming pools, comprising: (a) a pump-assisted circuit for circulating saltwater to and from a swimming pool; (b) means for determining the pH of the saltwater, preferably a pH sensor; (c) an electrolytic pH control cell with an inlet and outlet connected to the pump-assisted circuit for receiving and discharging saltwater from/to the pool, respectively, the pH control cell having at least one pair of electrodes arranged for creating an alkaline and an acidic chemical species from saltwater flowing through the cell, the cell comprising a water flow-through compartment in which one of the electrodes is located and a species separation compartment in which the other of the electrodes is located, the compartments being separated by a separator structure which is permeable to cation and anion transfer and restrictive to electrolyte flow between both compartments; (d) a drainage structure arranged for selectively draining liquid from the species separation compartment in controlled manner to waste; and (e) a controller functionally operative to (i) compare the pH determined or sensed with a desired pH value, (ii) apply an electric potential across the, electrodes of the cell and control one or bath of the potential and electric current supplied to the electrodes as a function of the pH comparison, and (iii) regulate drainage of an alkaline or acidic species which has been electrolytically generated within the separation compartment from pool water flowing through the flow-through compartment as a function of positive or negative potential being applied to the electrode in the species separation compartment.

In operation of the pH control cell, with saltwater being pumped at a selected rate through the flow-through compartment, and saltwater being present in the species separation compartment of the cell, the electrochemical reaction at the negative electrode (cathode) changes the chemistry of the saltwater in contact with it in accordance with the reactions described above. This process generates a liquid that can be referred toy as a catholyte. In essence, it is still saltwater, but with alkaline chemical species added to the initial liquid charge, with the degree of alkalinity depending upon various adjustable parameter's of the system, including one or both of electric potential difference across the electrodes and current flow between the electrodes of the cell. Hydrogen gas also produced at the cathode is preferably collected at a gas head space within the cell and ultimately dispersed safely. At the other electrode, the positively charged anode, an anolyte is produced by the chemical reactions described above, which ultimate leads to acidic chemical species being added to the saltwater as it flows through the cell. The anolyte also carries chlorine produced at the anode and oxidants mixed into the water, being oxidizing agents containing at least oxygen and/or chlorine in various chemical forms.

Noting that in most cases saltwater pools tend towards alkaline pH over time, it is particularly preferred to devise the system controller to be operative to apply a negative potential to the electrode within the species separation compartment sufficient to drive hydroxide ion (OH⁻) production from saltwater and produce an alkaline catholyte, and H₂, in the species separation compartment wherein catholyte can then be drained in a controlled and selective manner to waste (or storage for alternative uses) and H₂ gas accumulating at a gas head space of the compartment vented preferably into the saltwater stream of the flow-through compartment. A positive potential will be present at the electrode in the flow-through compartment sufficient for producing an acidic anolyte from saltwater flowing in the flow-through compartment of the cell. The net output of liquid from the cell towards the pool water return line will thus be acidic, lowing pH in the pool.

In contrast to a conventional in-line chlorinator, in which the anolytes and catholytes created during electrolysis within the cell are mixed downstream of the electrodes and returned to the pool, thus creating a chlorinated and potentially basified (alkaline) stream of salt water, carrying hydrogen gas as well as some mixed oxidants and other electrochemically generated species, the presently disclosed embodiment requires the electrolysis output streams to be kept separate in compartments that are chosen large enough in volume to allow effective separation of alkaline and acidic electrolyte. The pH of the net output fluid from the pH control cell to pool can then be controlled by discharging in controlled manner part or all of either the alkaline catholyte or the acidic anolyte to waste without mixing it into the output liquid stream which recirculate back to the pool.

The output stream can be chosen to be alkaline by discharging some of the acid anolyte, or acidic by discharging of some of the alkaline catholyte, or neutral. If anolyte is dispensed to waste for pH control reasons, then the chlorine generated in the pH control cell will be simultaneously lost as it is dissolved in the anolyte. In pools requiring this, that is, in the small minority of pools that tend to go acidic, supplemental chlorination will be required over time.

The drainage structure will at include a variable flow valve so that the drainage rate of liquid from the separation compartment can be set to a predetermined value. In its simplest form it can be a crimp valve. A peristaltic pump could also be used, this providing the added functionality of allowing pump assisted, more precisely metered draining (rather than purely gravitational purging) of the compartment). Drainage rates are very slow compared to flow rates of pool water through the flow-through compartment of the cell. Drainage rates can be set at between 0.1 to 1.0 ml per second (0.36-3.60 1 per hour), noting that the pH cell will not be operated on a continuous basis but intermittently, thus avoiding unnecessary loss of saltwater volume from the pool. Ultimately, drainage rate is a function of separation compartment volume, saltwater flow-through rate through the cell, leakage rate between flow-through and separation compartments across the separator structure between the compartments, hydroxide or migration rate through the separation structure, and needs to be fast enough to exchange the electrolyte contents within the separation compartment in a time that is short compared to the duty cycle of the cell when running as an acid generator (see below).

The cell will preferentially be operated such that the concentration of chemical species the discharge is high, so that the pH of discharged liquid is quite alkaline (greater than 11), or quite acidic (less than 3), depending on the polarity applied to the electrode in the separation compartment of the cell. The result is that the of the pool will be shifted by removing a small volume of liquid at an extreme pH at the cell. When neither catholyte nor anolyte are dumped to waste, then the net output stream from the pH control cell is either unchanged or slightly more alkaline than the incoming saltwater.

The removal of catholyte (or anolyte where the potential to the electrodes has been temporarily reversed) from the pH cell's separation compartment may be assisted by pumps, venturis, other mechanical devices or gravity, depending upon the hydraulic set-up of the pool in any one situation.

It is possible to measure the pH aria ORP levels of the output of the pH control cell directly at the cell, but typically this is not necessary. If electronic sensors are located after the pool filter and before the pH control cell, then the resultant pH and ORP of the pool can be sensed and used to appropriately control the liquid output of the cell. Optimally, a discharge rate to waste is chosen whereby the chlorine and pH are simultaneously optimised.

Under alkaline conditions, some dissolved salts may precipitate as solids, usually hydroxides or carbonate compounds, at the cell. For instance, dissolved calcium may precipitate as “lime scale”, which is principally a complex mix of hydroxide and carbonate salts of calcium. These residues may foul the separation structure of the cell which allows ion transfer between the compartments of the cell, valves and other cell structures, which if unchecked, may cause device failure or reduced lifetime of components. As these residues are usually redissolved by acid, the pH control cell can be ‘switched’ (through its controller) to clean itself. For instance, after a period of operation in one polarity, in which some residue forms in the alkaline compartment, the polarity can be briefly reversed while drainage from the separation compartment to waste is stopped, to produce an acid environment to dissolve the residue. After a period of time, the separation compartment is flushed by draining to waste, and normal operation is then resumed.

In one preferred aspect the above system, the pH control cell works together with a separate, in-line salt water chlorinator located downstream in the pool water recirculation circuit such as to allow for the pH control cell to work at an operating point optimised for pH control (vs chlorine generation) and allowing the dedicated saltwater chlorinator cell to be a primary chlorine source for sanitation. Such arrangement provides improved efficiency and improved cell electrode (plate) maintenance at both the pH control and chlorinator cells.

Normally, conventional in-line chlorinator cells in a properly managed saltwater pool are fed with pool water at a pH from 7.2 to 7.8, which produces chlorine as well as some oxidants, being a mixture of oxygen, hydrogen and chlorine compounds, some of which are useful as a sanitiser, for example, hydrogen peroxide. If, in accordance with the presently disclosed embodiment, the pH control cell is set to feed the conventional in-line salt chlorinator with a stream of saltwater at below pH 7.0, then the mixture of compounds produces changes and can include, for example, chlorine dioxide, which is an excellent sanitiser. The chlorinator also tends to operate more efficiently and at higher electrical currents for the same salt concentrations at lower pHs.

In normal operation with both the pH control cell operating to deliver an acidic saltwater stream and the chlorinator cell operating to deliver chlorine, feeding an acidic saltwater stream to the chlorinator cell also reduces the deposition of Calcium Carbonate on the anode of the chlorinator cell. This is normally a significant problem in in-line pool chlorinators. Calcium deposition typically needs to be removed by either regular removal of the electrodes and acid washing, or by reverse polarity operation. Reverse polarity operation appreciably decreases the allowed current density in the electrode plates by a factor of at least 3 and often 5, depending on the coating on the plate. It necessitates larger electrode plates by said factor and also means that both anode and cathode of the chlorinator cell must be coated with an expensive material such as Ruthenium or Iridium oxide or Platinum, depending on the technology being used. Reverse polarity operation also reduces coating life by a significant margin.

Furthermore, not only will the acidic saltwater output stream from the pH control cell be beneficial in normal operation, but it can also be used to clean the in-line chlorinator plates. This is done by setting the controller of the pH control cell to ‘minimum pH setting’, by increasing the electric current to the electrodes and/or reducing flow of saltwater by the pool pump (or dedicated cell pump), switching off the chlorinator cell and reducing filter speed to very slow so as to push a stronger acidic saltwater stream than normal into the chlorinator cell. This can also be done by stopping and starting the filter pump or in other ways but the essence is that either a stronger acidic saltwater stream is caused to flow continuous into the in-line chlorinator or it is pushed in in batches and allowed to reside for a period appropriate for the acid scrubbing alkaline deposits and thus cleaning the plates, before being refreshed or terminated as the case might be. This avoids the need for manual or other acid cleaning, or, reverse polarity operation in the in-line chlorinator.

As hinted previously, the system can furthermore be devised/controlled such that the controller of the pH cell is operative to apply a positive potential to the electrode within the flow-through compartment sufficient to produce an effective amount of chlorine from saltwater within the flow-through compartment of the cell to enable the pH control cell to simultaneously serve as a sole chlorination source for the swimming pool.

In a second aspect of the presently disclosed embodiment there is provided method for electric pH control of saltwater swimming pools, comprising: (a) determining the pH of saltwater in a swimming pool or flowing through a swimming pool water recirculation circuit; (b) circulating saltwater to and from the swimming pool past a saltwater electrolysis cell, the cell arranged for generating alkaline and acidic chemical species from saltwater using at least one pair of cell electrodes, the cell comprising a flow-through compartment in communication with the pool water recirculation circuit and in which one of the electrodes is located and a species separation compartment in which the other of the electrodes is located, the cell compartments being separated by a separator structure which is permeable to cation and anion transfer and restrictive to—yet preferably not fully blocking of—electrolyte flow between both compartments; (c) selectively applying an electric potential difference across the electrodes as a function of the pH determined and a desired pH of the pool water to produce alkaline or acidic chemical species from the saltwater at the electrode in the species separation compartment while maintaining pool water flow in the flow-through compartment; and (d) selectively draining liquid containing the alkaline or acidic chemical species from the species separation compartment away from the pool water.

In a third aspect, the presently disclosed embodiment provides a method for electrolytic pH control and chlorination levels of saltwater swimming pools, comprising: a) determining the pH and ORP (or chlorine) levels of saltwater in a swimming pool; (b) circulating saltwater to and from the swimming pool past a saltwater electrolysis cell, the cell arranged for generating chlorine and alkaline and acidic chemical species from saltwater using at least one pair of cell electrodes, the cell comprising a flow-through compartment in communication with the pool water recirculation circuit and in which one the electrodes is located, and a species separation compartment in which the other of the electrodes is located, the cell compartments being separated by a separator structure which is permeable to cation and anion transfer and can be either fully blocking of or strongly restrictive to electrolyte flow between both compartments; (c) selectively applying an electric potential difference across the electrodes as a function of the determined pH and chlorine level and a desired pH and desired chlorine level in the pool water, whereby the electrode in the species separation compartment is negative relative to the electrode in the flow-through compartment so that chlorine and acidic chemical species are produced from the saltwater at the positive electrode and hydroxide is produced at the negative electrode in the species separation compartment; and (d) maintaining pool water flow in the flow-through compartment for delivering the chlorine and acidic chemical species produced during electrolysis into the pool water circulation circuit and selectively draining liquid containing the alkaline chemical species from the species separation compartment in controlled manner away from the pool water.

Control of the chlorine and pH levels at chosen set-points in the pool can be advantageously achieved using closed loop control of the components of the net output liquid stream of the electrolytic pH control cell (these being liquid passing through the flow-through compartment and liquid contained and selectively drained to waste from the species separation compartment of the cell) using, for example, electronic ORP and pH sensors which would usually be located upstream of the cell in the recirculation/filtration line for swimming pool water. As noted, the other operating variables of the pH control cell that can be controlled and set are the potential difference applied across the electrodes and the electric current supplied to these.

One of the advantages provided by the different aspects of the presently disclosed embodiment can be seen in the elimination (or at least substantive reduction) of a need to store acid and/or alkali on-site the swimming pool location in order to effect pH control and also eliminating the need to dispense stored acid or alkali manually or via some metering system, given that such control is effected by ‘manipulating’ the saltwater of the pool itself.

Another benefit that flows from implementing the inventive aspects is a reduction or complete removal of the need for a dissolved buffer solution in the pool, such as sodium bicarbonate. Sodium bicarbonate is no longer required as the presently disclosed embodiment provides both acid and alkali control; buffer can optional be used in conjunction with the presently disclosed embodiment where there is a natural tendency for pools to drift to be acidic.

In a further aspect, the presently disclosed embodiment provides a swimming pool pH control cell, comprising: (a) a water flow-through compartment within a housing and which can be coupled into a pump-assisted circuit for circulating saltwater between a swimming pool and the cell; (b) a species separation compartment at or within the housing, arranged to receive saltwater from the swimming pool, preferably via the flow-through compartment, and having a drainage arranged for selectively draining liquid from the species separation compartment in controlled manner to waste, preferably through controlled valve; (c) a separator structure between the compartments which is permeable to cation and anion transfer and which is blocking of or restrictive to electrolyte flow between both compartments; (d) at least one pair of electrodes arranged for creating an alkaline and an acidic chemical species from saltwater flowing through the cell, one of the electrodes located in the water flow-through compartment and the other located in the species separation compartment, the electrodes being connectable to a DC electricity source for effecting saltwater electrolysis; and (e) a controller operative on the electrode pair and having a controller functionally devised for (i) comparing a sensed pH of pool saltwater with a desired pH value, (ii) controlling one or both of electric potential across the electrodes of the cell and electric current supplied to the electrodes as a function of the pH comparison and (iii) regulating drainage of an alkaline or acidic species produced by electrolysis from saltwater within the separation compartment from pool water flowing through the flow-through compartment as a function of positive or negative potential being applied to the electrode, in the species separation compartment.

In its simplest form, one of the control functionalities in the different aspects of the presently discloses embodiment could be performed in a semi-automated manner, wherein the pH is determined manually and compared with a desired/optimal pH level for a given swimming pool based on sanitation/chlorine settings, and based on a look up table (stored in controller memory) the electrolytic cell is then activated automatically and run (e.g. timer controlled) for a time sufficient to achieve the desired pH change, with draining of the species separation chamber being performed manually as well.

However, it will be immediately appreciated that the different aspects are best performed in a fully automated implementation. A micro-processor controller can be suitably programmed and appropriate sensors and actuators can be provided at the cell/pool water recirculation circuit, and linked to the controller, to effect pH control in automated fashion in a closed (or open) control loop.

Advantageously, the species separation compartment is located within the housing in the flow through compartment or at the housing besides the flow-through compartment, separated from the latter by the anion and cation separator structure. The species separation compartment can hereby be devised to receive saltwater via the flow-through compartment via a suitable lock structure or mechanism, as described below, or through a separate line with flow regulation valve, from the pool recirculation circuit.

The species separation compartment will advantageously be provided with facilities for one or more of, but preferably all of (i) venting of as generated during electrolysis of salt water, (ii) for maintaining a gas lock between the flow-through compartment and the species separation compartment to keep the liquids in the respective compartments separate from one another during electrolysis of saltwater, (iii) for allowing liquid ingress from the flow-through compartment into the species separation compartment when the latter is being drained, and (iv) for liquid fill (or level) control of the species separation compartment to ensure that the electrode located therein remains fully submerged during the electrolysis process.

These facilities may be provided dedicated mechanism/devices/structures such as valves, pumps and sensors which may be actively controlled, or passive structures that utilise hydraulic principles in achieving such functionality. Such structures are described below and identified in the claims at the end of this specification.

The separator structure between the flow-through and species separation compartments can be described as a ‘porous’ separator in that while it aims to substantially restrict passage of liquid through it, it has a degree of permeability to liquid passage at extremely low rates, the porosity being chosen to substantially prevent bulk liquid flow between the compartments while ensuring adequate exchange of ions between the compartments. Material selection of the separator structure is also predicated to allow electrical current flow between electrodes to effect electrolysis.

In a preferred aspect, the porous separator structure can include a polymer membrane having a thickness in the micrometer range, covering a window in a liquid-impervious wall separating the flow-through and species separation compartments. Such membrane will preferably be inert (i.e. not having inherent polarity preferences), the many fine pores being sized to allow water containing dissolved salts to provide the path for electric flow across the membrane between the electrodes, with low electrical resistance. The porosity will be chosen to restrict the flow of bulk liquid through the partition membrane to a flow rate that is at least an order of magnitude smaller than the drainage rate at which liquid is drained in controlled fashion from the species separation compartment and orders of magnitude smaller than the flow rate of saltwater from the pool through the flow-through compartment defined within the housing of the cell. In a specific example of such membrane, applicants have selected a microporous hydrophilic PTFE membrane laminated on a non-woven polypropylene substrate, “JMTL-100” from Anow Microfiltration Company, PR China. Such composite membrane is about 120 microns thick, the PTFE layer being about 20 micron, with pore size 1 micron. The PTFE membrane is believed to be furthermore quite resistant to the chemical environment in the cell.

Relevantly, the membrane base material should be selected also to take account of the relatively chemically aggressive environment of the anolyte or catholyte in the species separation compartment in particular to achieve acceptable ‘wear’ properties. In that regard also, the housing of the cell will advantageously be constructed to allow access to and replacement of the separator membrane (or other structure), which is mounted within the housing between the flow-through and species separator compartments, when and if required.

The electrodes used in the cell are preferably plate-like in design so as to extend parallel and closely spaced on either side of the planar separator structure, only a few millimetres apart. While the plates could simply be flat and rectangular, they could also be concentric cylinders or have other shapes.

All structures used in the manufacture of the cell are made from materials that are chemical resistant to acidic, alkaline and oxidising environments, including chlorine hypochlorous acid and hypochlorite.

Preferred aspects of tie presently disclosed embodiment, and optional features thereof, will be described herein below with reference to the accompanying drawings.

### BRIEF DESCRIPTION OF DRAWINGS

FIG. 1 shows a schematic and simplified recirculation and filtration circuit for a saltwater swimming pool, into which an inventive electric pH control cell has been plumbed in-line downstream the pool filter, in a first aspect of a system for electric pH control of saltwater swimming pools in accordance with one aspect of the presently disclosed embodiment;

FIG. 2 shows a schematic and simplified recirculation and filtration circuit for a saltwater swimming pool, into which an inventive electric pH control cell has been plumbed in parallel flow, by-passing the pool filter, according to a second aspect of a system for electric pH control of saltwater swimming pools in accordance with one aspect of the presently disclosed embodiment;

FIG. 3 is a schematic, vertical section of an embodiment of an electrolytic cell in accordance with another aspect of the presently disclosed embodiment, for use as the pH control cell in the systems of FIG. 1 or 2;

FIG. 4 is an enlarged detail view of the upper portion of the separation compartment located within and forming part of the cell illustrated in FIG. 3;

FIG. 5 is a plotted pH—time graph illustrating results of a pH control experiment conducted on a small volume of NaCl-salted water using an experimental pH cell such as schematically illustrated in FIG. 3;

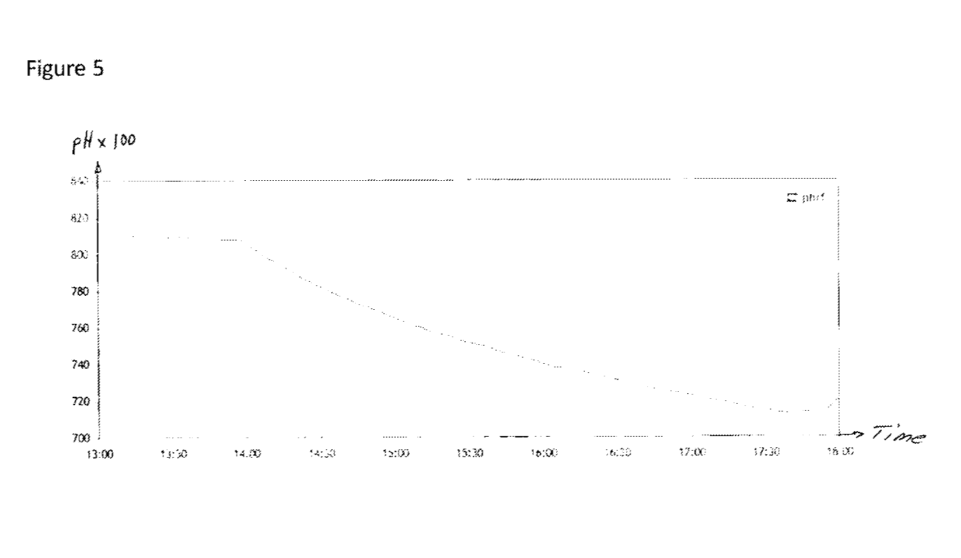

FIG. 6 shows a graph with pH and ORP curves over a 21 day period, of water in a 45,000 litre salt water pool, whose pH was controlled using the experimental pH cell schematically illustrated in FIG. 3 in accordance with the aspect of FIG. 2; and

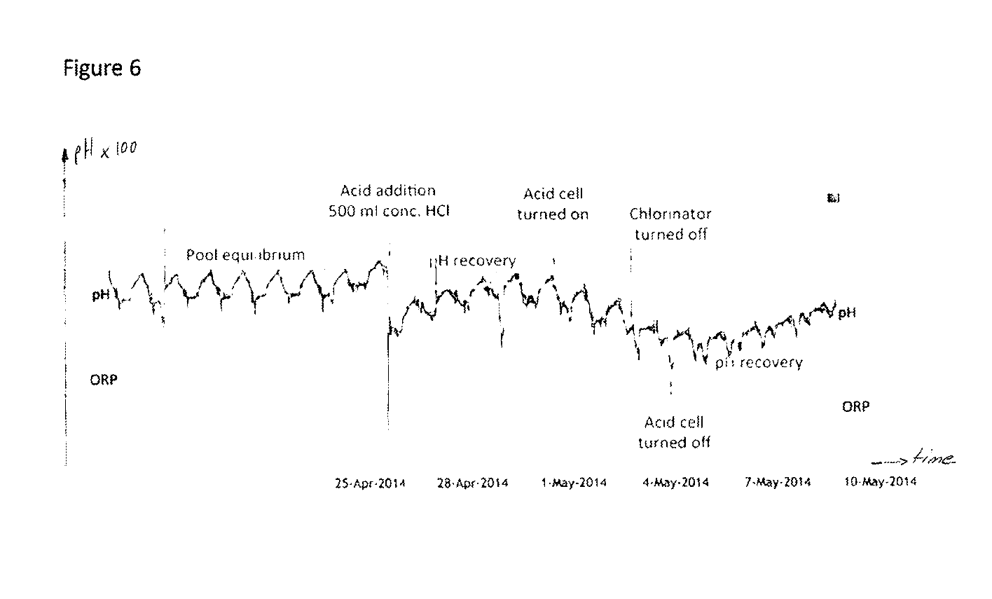

FIG. 7 shows a second aspect of an electrolytic cell, schematically, in accordance with the presently disclosed embodiment, whereby same reference numbers as appear in FIGS. 3 and 4 have been used to denote functionally equivalent cell components.

### DETAILED DESCRIPTION

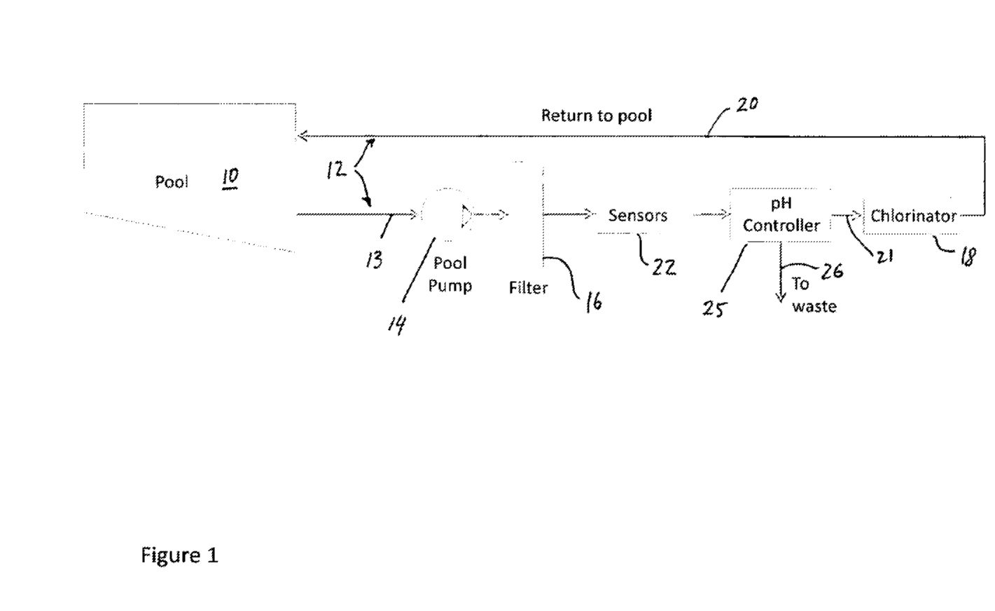

FIG. 1 schematically illustrates a saltwater swimming pool 10 with a conventional water filtration and recirculation circuit 12. Circuit 12 draws saltwater from pool via suction line 13 using pool pump 14. Saltwater is circulated into rapid sand filter 16 for particulate matter scrubbing, and directed into an inline chlorinator in form of a conventional electrolytic cell la for adding of chlorine. The scrubbed and chlorinated water is returned via return line 20 to pool 10. Box 22 denotes summarily a suite of pool water quality sensors, including in particular sensors for determining pH and oxidation reduction potential (ORP) of water passing through the pipe work from/to pool 10. Water salinity can be set to between 2,500 to 6000 ppm sodium chloride by dissolving solid salt into the pool water as practiced conventionally. Salt need only be replaced when water levels in the pool are topped-up, due to, backwashing water losses or draining of water in the process of pool cleaning or after heavy rain, as normal evaporation of pool water leads to concentration of salt level.

The pool water recirculation circuit components are conventional in nature and well known to the skilled pool operator. Circuit components such as valves, power supply circuitry for the pump and chlorinator cell, optional pool water heating recirculation equipment and infrastructure, and pool equipment control circuitry, which in its simplest form would include a timer for setting operating times of the pump and chlorinator, have been omitted for clarity purposes.

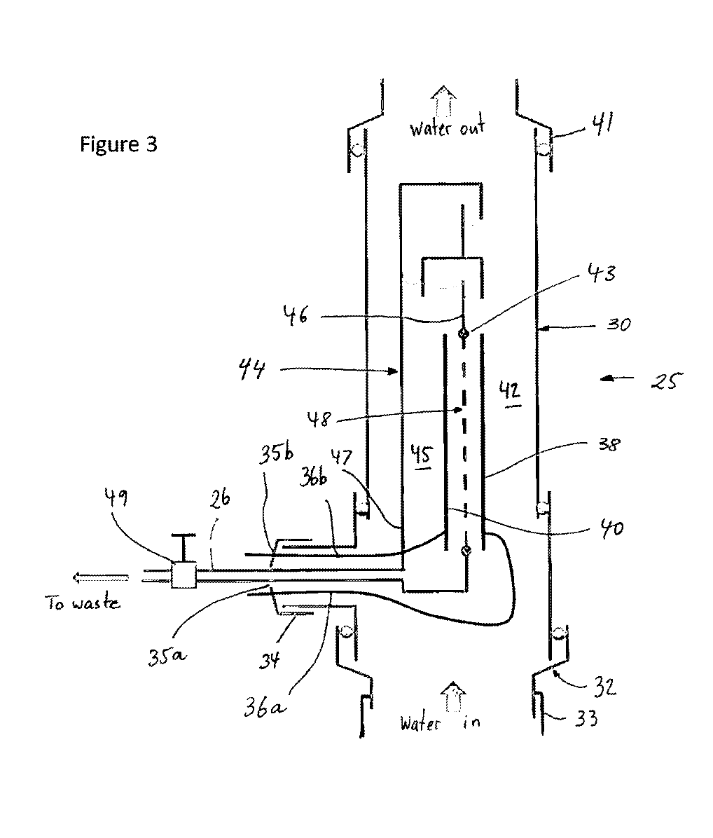

In accordance with a first aspect of the circuit lay-out, an electrolytic pH control cell 25 (also referred to as a pH controller) in accordance with one aspect of the presently disclosed embodiment is mounted (plumbed) in-line downstream the sensor suit 22 and upstream the chlorinator cell 18 in the water recirculation circuit 12 to deliver saltwater passing through cell 25 into cell 18 via line 21. Relevantly, pH controller 25 is connected also to a liquid discharge pipe or line 26 for reasons which will be described in detail below with reference to FIG. 3, which drains part of the liquid received in cell 25 towards waste (e.g., sewerage).

In the circuit of FIG. 1, noting that the water flow rate and pressure will be dictated by the pool pump 14 and hydraulic parameters of the filter 16, water pipes/lines and valves in the circuit 12, in order to ensure adequate operation of pH controller 25, controller 25 may be partially by-passed by an appropriately sized or valve-controlled pipe (not shown) chosen to bypass a set (or otherwise controllable) amount of pool water towards chlorinator cell 10. Equally, care must be taken that the water-flow through the line downstream controller 25 has sufficient pressure to clear any accumulation of air or gas in that section of pipe and from the pH controller back into the pool for release to the atmosphere, as will become clear later on.

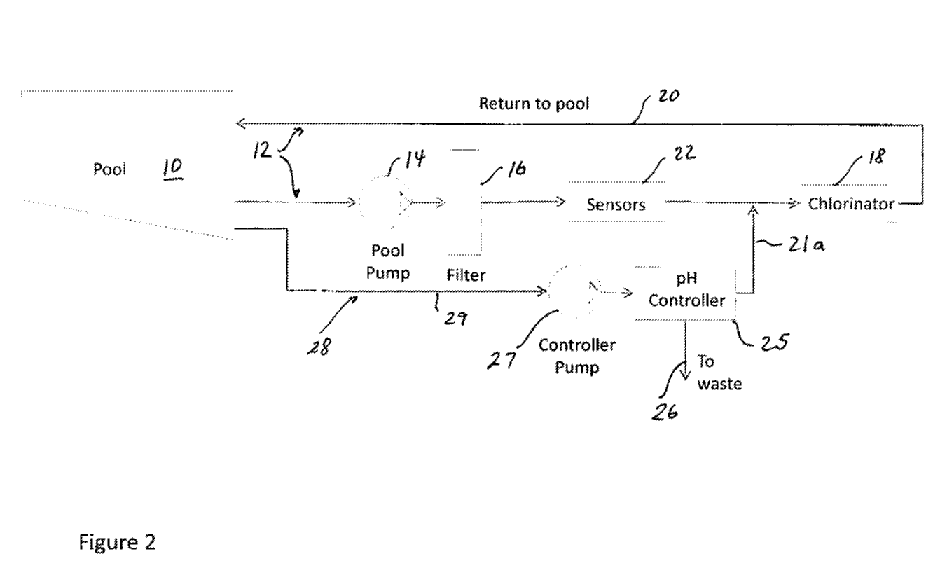

In accordance with a second circuit lay-out, as shown in FIG. 2, the controller 25 may instead be located within a dedicated pH control line 28 Which draws pool water from pool 10 via a suitably sized suction pipe 29 through a separately controlled controller pump 27, thus by-passing pool pump 14 and filter 16. Pool water can thus be pumped through pH controller 25 at a separately controlled rate independent from the flow rate of the filtration circuit 12, from where it is supplied into the recirculation circuit 12 upstream of chlorinator 18 through appropriate plumbing 21a.

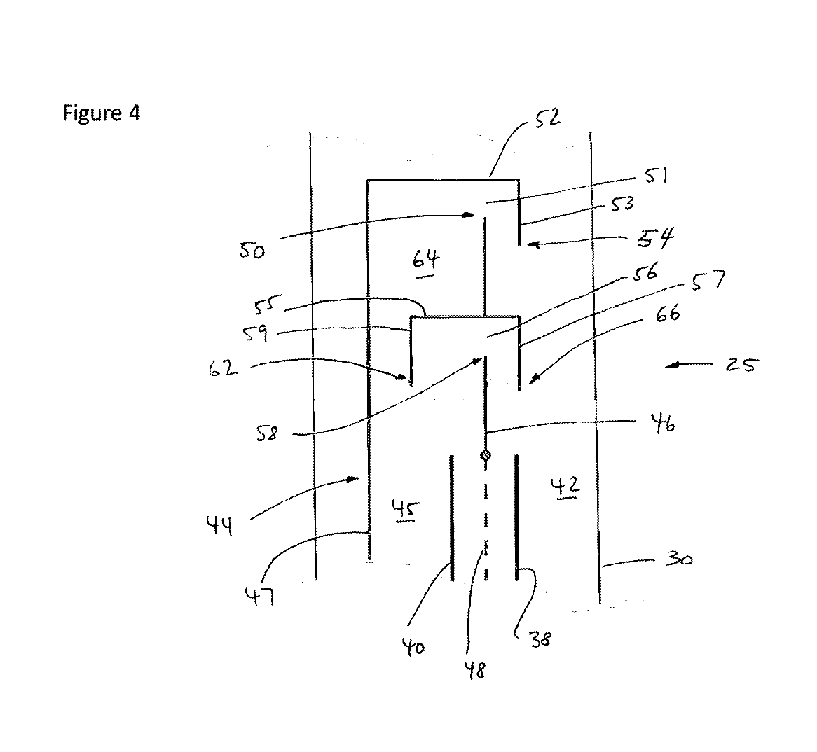

Turning then to FIGS. 3 and 4 which illustrate schematically the make-up of an experimental electrolytic pH control cell 25 as manufactured by the applicant, reference number 30 denotes the cell's primary housing, a clear PVC pipe section with an outside diameter of 90 mm, inside diameter of 80 mm and length of 700 mm. In operating cell 25, housing 30 will be mounted oriented vertically. The lower end of cell body 30 is inserted in sealing engagement into an upper arm of a T-piece pipe fitting 32. The lower vertically oriented port of the T-piece 32 is devised for coupling with a pool water inlet hose or pipe via suitable pipe fittings (schematically alluded to at 33), so that pool water can be pumped from the pool 10 into the lower end of the hollow cell body (housing 30). The horizontally oriented port of the T-piece 32 is sealed with a PVC cap 34 which contains a central port 35a to pass through the above mentioned cell drain line or pipe 26 in sealing manner, and separate side ports 35b for electrical cables 36a and 36b of the cell's two electrodes 38, 40 without leakage. The upper end of cell body 30 is in turn coupled via a suitable pipe fitting (shown schematically only at 41) to a hose or pipe which feeds into chlorinator cell 10 as per FIG. 1 or 2. Consequently, pool water will enter cell 25 via T-piece 32 and pass through flow channel or compartment 42 defined within hollow pipe section 30 for discharge via pipe fitting 4l for return to pool.

A liquid separation compartment 44 is present inside the cell's main body (pipe) 30, preferably with sufficient spacing from the tubular wall of pipe section 30 to minimise flow constriction for pool water passage within flow compartment 42. Separation compartment 44 is a box-like hollow structure fabricated from 3 mm thick acrylic sheet wall sections bonded with silicone elastomer, defined an inner enclosure or chamber 45, and is substantial rectangular prismatic in shape, with height of 550 mm, width of 66 mm and depth of 26 mm. A rectangular window 420 mm high and 40 mm wide is cut in the acrylic sheet providing one of the walls 46 of the liquid separation compartment 44. A liquid separation membrane 48 mounted over this window using silicone elastomer adhesive to form a leak-proof seal 43 around the window's perimeter. Membrane 46 thus separates the flow compartment 42 defined within cell body 30 from the chamber 45 defined inside of separation compartment 44. Membrane 46 is preferably a microporous polypropylene foil with PTFE coating, 25 to 125 micron thick with 55% pore volume fraction, and an average pore diameter of 64 nanometres to 1 micron, but could be made from other materials capable of operating in salt water concentrations typically encountered in domestic swimming pools without fouling. A relevant selection criterion for the membrane, which could be thicker than foil material, is its capability for adequate ion transfer in the process of electrolysis of salt water, as will become clear later on.

It will be noted from FIG. 3 that drainage line 26 connects sealing fashion into a port formed at or near the lower end of vertical wall 47 of separation compartment 44 so as to communicate with chamber 45, opposite the membrane-carrying wall 46. A manually,but preferably otherwise operated valve 49 (e.g. pneumatically, electrically, hydraulically) is present in discharge line 26 to control the rate of flow of liquid that may pass through drain line 26 from chamber 45 of separation compartment 44, towards waste as is explained below.

The two electrodes 38, 40 of electrolytic pH control cell 25 are fabricated from 0.5 mm thick titanium plates coated on each side with a catalytic coating of rare earth metal oxides, primarily ruthenium oxide and iridium oxide. The electrodes 38, 40 are 430 mm high and 50 mm wide plates, secured within cell 25 by way of small acrylic bracket structures (not shown) affixed to the wall 46 featuring the window, either side of and parallel with membrane 48 so that one electrode 40 is located in the chamber 45 inside the liquid separation compartment 44 and the other electrode 38 is outside thereof in the flow channel 42 defined the cell's main body (tube section 30). Electrode separation is approximately 9 mm, and a small hole is drilled in each plate so that electrical connection to each plate is made with insulated wires 36a and 36b whose exposed ends are received in the holes and encapsulated using an epoxy putty to prevent contact with pool water and other liquids. The electric wire 36a connected to the inner electrode 40 is passed through a small port in wall 47 of separation compartment 44 opposite the membrane covered window, and appropriately sealed off to prevent leaks. As is known from conventional electrolytic cells, the electrodes 30, 40 will be connected to a switchable DC power supply (not shown) in known fashion.

The box-like structure of separation compartment 44 is provided with fixtures to (i) enable liquid level control within cavity 45 of compartment 44, (ii) permit venting of gas generated as a by-product of salt water electrolysis within cavity 45 of separation compartment 44, (iii) allow liquid re-filling to replace liquid selectively drained through drainage line 26 from cavity 45 of compartment 44 and (iv) provide a gas lock (as in an air lock) to ensure that liquid contained within the separation compartment cavity 45 is discontinuous from the pool water flowing outside the separation compartment 44 in the flow-through compartment 42 defined within cell body 30.

Rather than having actively controlled valves and similar fixtures with moving parts to effect the above mentioned functions, the inventive pH controller 25 is devised with a set of what will be termed passive, constructional elements at an upper region of the separation compartment 44 to provide the required functionality These constructional elements are schematically shown in FIG. 4. Essentially, the stated functionality can be achieved using a number of weirs and inverted weirs, identified at 50, 58 and 54, 62, 66, respectively, in FIG. 4. A weir (such as at 50 and 58) is a structure which confines a body of liquid until a rise in liquid level allows the liquid to spill over it. Analogously, an inverted weir (such as at 54, 52 and 66) is a structure which confines a submerged body of gas until a drop in liquid level allows the gas to bubble out from under it.

The weirs 50, 58 and inverted weirs 54, 62 and 66 which achieve the required functions at the liquid separation compartment 44 are created by providing rectangular windows or slots 51, 56 in the wall 46 above the membrane 48, and using sections of the same acrylic sheet material which make up the walls of box-like separation compartment 44. Slots operate more reliably as they are less prone to blockages or vapour locks than circular or low aspect ratio holes.

There is provided one upper set of weir and inverted weir 50, 54 about a rectangular cut out (slot) 51 in the terminal upper edge of wall 46, and one lower set of a weir 58 and two inverted weirs 62, 66 about a lower rectangular window 56 in wall 46 above the membrane covered window of compartment 44. It should be noted though that the upper weir and inverted weir set 50, 54 need not necessarily be present in the same wall as the lower weir and inverted weir set 58, 62, 66.

Clearances between the acrylic sheet pieces comprising these structures, and the height overlaps of the weirs and inverted weirs should exceed the capillary length, which is the length scale over which gravitational forces on a liquid are larger than capillary forces. This ensures the behaviour of quid interfaces in the complex structures is reliable and predictable and not confounded by capillary rise and meniscus curvature of liquid The capillary length λ is given by the formula

λ=√(γ/ρg)

where γ is surface tension, ρ is density, and g is gravitational acceleration. The capillary length of clean water is about 3 mm. Consequently the weir and inverted weir structures 50, 54, 50, and 66 within the upper part of the inner compartment 44 have clearances and defined level differences of preferably about 5 mm (but could be greater if desired).

It will be noted that the otherwise open upper end of compartment 44 is capped off in sealing manner by a top plate 52 which is 26 mm wide and protrudes beyond vertically extending wall 46 to cooperate with a vertically extending face plate 53 to define the upper inverted weir 54 outside the cavity 45 of compartment 44. A horizontally extending shelf plate 55, which is 18 mm wide, is inserted into the lower rectangular slit 56 formed in wall 46 and secured (bonded) to the upper edge of slit 56 at wall 46 to protrude into the cavity 45 defined within compartment 44 and cantilever to similar extent than top plate 52 on the outside of compartment wall 46. An outer face plate 57 is secured to depend vertically from the outside terminal edge of shelf plate 55 to define the externally located lower inverted weir 66, whereas an inner face plate 59 is bonded to the inner terminal edge of shelf plate 55 to depend vertical therefrom. The upper weir 50 has a clearance of 10 mm height, and the three inverted weirs 54, 62 and 56 have a clearance height of 13 mm. The lower terminal edge of face plate 53 of upper inverted weir 54 is 5 mm lower than the top edge of the upper weir 50, and the lower terminal edge of external inverted weir face plate 57 is 5 mm lower than the top edge of the lower (normal) weir 58.

While the upper set of weir and inverted weir 50 and 54 provide the above mentioned gas venting facility to allow gas generated during saltwater electrolysis, which is ‘trapped’ in the head space 64 defined between the lower and upper weir sets within the separation compartment 44, to escape into water streaming past outside of separation compartment 44, the set of lower external inverted weir 66 and normal weir 58 provide the liquid refilling functionality noted above and whose function is described in more detail below.

The location of the terminal lower edge of face plate 59 of the inner inverted weir 62 sets the lower liquid-fill control level of chamber 45 within separation compartment 44. In the experimental cell 25 described herein and manufactured by the applicant, this edge is situated 85 mm above, the upper edge, of the inner electrode 40, thereby ensuring electrode 40 is always submerged during operation of the pH control cell 25, as explained below.

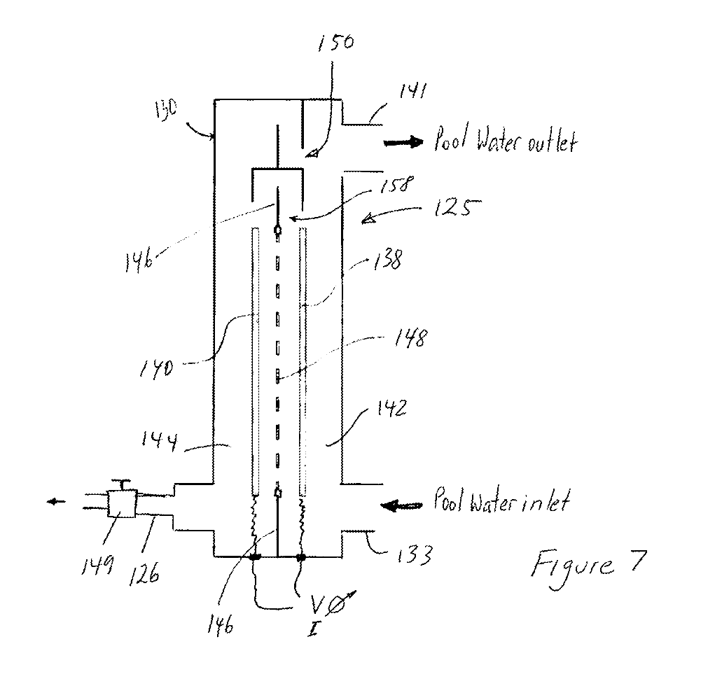

Before turning to describing the operation mode of the electric pH control cell, attention is drawn to FIG. 7 which shows a highly schematised and simplified further aspect of such cell, whereby it is very similar to the one described with reference to FIGS. 3 and 4, and thus uses the same reference numbers (but with an increment of 100) to denote similar components, but for the differences noted in the following.

Housing 130 is not tubular but box like in configuration, with an internal separation wall 146 subdividing the hollow space into unequally sized chambers such that the flow-through compartment 142 is arranged parallel with and to one side of the liquid separation compartment 144. Pool water supply line 133 and ‘treated’ (pH adjusted) pool water return line 141 connect in a manner previously described via suitable pipe fittings to the flow-through compartment 142 of upright installed cell 125 at its lower and upper end, respectively.

Separation all 146 has inverted upper and lower weir structures 150 and 158 substantially as previously described. Equally, separation wall 146 has a rectangular window which is covered by micro porous membrane 148 as described above, with anode and cathode electrodes 138, 140 being mounted in flow-through and species separation compartments 142, 145 respectively, and connected to an electric voltage source. A drainage arrangement comprising simple crimp valve 149 and pipe 126 allow drainage of species separation compartment (chamber) 145 as previously described.

The box-like housing configuration with inner separation wall 146 facilitates manufacture of the cell 125 either from injection moulded, chemically resistant polymer housing parts, suitably welded together or otherwise sealingly secured to one another to allow access to the exchangeable separation membrane 148; assembly from discrete poly carbonate sheet sections welded to one another is an alternative manufacturing option, as are 3-D printing techniques.

In the following, operation of the pH control cell 25, and in particular the weir structures, will be described with reference to FIG. 4; an analogous mode applies to the cell aspect 125 of FIG. 7.

Initial filling of the species separation compartment 44 (i.e. its inside cavity 45) with electrolyte (i.e. saltwater) takes place in the process of bringing cell 25 on line when pool water is pumped through the recirculation circuit 12, as per the circuit lay out in FIG. 1, or when dedicated controller pump 27 in the pH controller line 23 of the circuit lay-out of FIG. 2 is turned on, as part of the pH control process. Pool water is pumped in to the bottom of cell 25, and fills flow-through compartment 42, and as water level rises above the top of the lower weir 58, it spills over the edge of the lower weir's vertical wall into the separation compartment's cavity (or chamber) 45, displacing air out past the upper inverted weir 54. Pool water can rise inside the inner (i.e. separation) compartment 44, but this will not completely fill cavity 45 because a gas headspace will be trapped at 56 below shelf plate 55 between the face plates 59 and 57 of inner and outer lower inverted weirs 62 and 66, and another gas headspace will be trapped at 51 between the face plate 53 of upper inverted weir 54 and the back wall 47. These two headspaces, and the membrane 48, separate saltwater received within the electric pH controller 25 into two discontinuous bulk bodies of liquid, one body within the cavity 45 of separation compartment 44, and one body surrounding compartment 44 within the flow-through compartment 42 formed within housing 30.

There is no means for free bulk (i.e. substantial) exchange of liquid volume between the two compartments once the inner (separation) compartment 44 has been filled and gas head spaces formed. There may be minor exchange of volume through the porous membrane 48, depending on its porosity and pressure gradients between inner compartments 44 and outer compartment 42, or by fillets of fluid retained in corners of the structure by capillary action. Relevantly, any such exchange does not compromise the functionality of the cell 25, as such fluid exchange is at least an order of magnitude slower compared to the electrolysis and pH adjustment processes of interest.

The purpose of separating the two bodies of liquid is to ensure that chemical alkaline species created in the saltwater contained within cavity 45 of compartment 44 during ‘normal’ operation of cell 25, in which inner electrode 40 is switched to a negative potential (thus becoming the cell's cathode) compared to the outer electrode 38 (which is thus the cell's anode), does not mix back into the main flow of saltwater flushing through flow-through compartment 42 of cell 25. When a sufficient voltage is applied and current supplied to electrode 40 within separation compartment 44, H₂ gas is liberated on the electrode surface. The H₂ gas rises through the saltwater in cavity 45 from the inner electrode 40 and bubbles into either of the two internal headspaces 56 and 64. The volume of the headspaces increases, until the gas escapes as bubbles from the inner compartment 44 by spilling over either the lower or upper outer inverted weirs 66, 54. In this process each headspace is maintained, and liquid segregation is also maintained while the gas can freely vent.

The liquid level in the cavity 45 of separation (inner) compartment 44 must not be allow to drop to expose the inner electrode 40, otherwise a hazardous condition may result from overheating of the electrode. By the same token, the cavity 45 of separation compartment. 44 must be slowly drained, at the same time as gas is being evolved within it. Under some conditions, liquid may also be lost by foaming action carrying some entrained liquid out past the inverted weirs. Therefore, the inner liquid level must be controlled such that the cell refills if the liquid drops below a lower control level.

The bottom edge of inner inverted weir 62 sets the lower control level. If the liquid in cavity 45 of the inner compartment 44 drops below the free edge of inner inverted weir 62, saltwater from the outer, ie flow-through compartment 42 (see FIG. 3) can spill over the lower weir 58 into cavity 45, while gas is displaced past the upper inverted weir 54 from separation compartment 44 to the flow-through (or ‘outer’) compartment 42 of cell 25. The liquid in the inner (separation) compartment 44 will rise until it reaches the lower control level at 62.

This requirement is the reason for the double inverted weir structure, rather than a simpler single inverted weir, such as a design in which the inner inverted weir 62 were absent Such a design would still separate the liquids within separation compartment 44 and flow-through compartment 42 into two bodies, allow gas venting, or allow refilling when being drained, but it would fail to maintain a lower control level when separation compartment 44 is simultaneously drained while the separation compartment's electrode 40 is producing gas.

The above described cell 25 has been tested in two environments. In a first experiment, cell 25 was used to control in a small amount of liquid, and to confirm operation of the liquid control level functionality provided by inner inverted weir 62 of the separation compartment 44 of cell 25, whereas in a second experiment, a large saltwater poll was subjected to pH control over an extended period of time.

In the first experiment, pH controller was installed next to a tank containing 500 litres of 6000 ppm NaCl water solution. A small pump circulated water from the tank to the bottom of the pH controller, through the cell 25 and back to the tank via a hose. An electric potential was applied to the electrodes, such that the (inner) electrode 40 within separation compartment 44 acted as the cell's cathode.

A small manual valve (as per 49 in FIG. 3) was set to drain the cavity 45 of separation compartment 44 at a constant slow rate. The pH and oxidation reduction potential (ORP) in the NaCl water solution was monitored using sensors attached to the tank.

The rate of flow of pool water through the pH controller was set to 6 litres per minute, whereas the rate of drainage of the separation compartment 44 was set to approximately 1 ml per second (60 ml per minute). A potential of 13.3 V was applied to inner and outer electrodes 40 and 38, which produced a current of 7.9 amps.

The change in pH with time through the experiment is shown on the graph of figure in which the vertical axis is pH multiplied by 100, and the horizontal axis is time in hours and minutes. The initial pH of the tank was 8.1. The pH dropped by a full pH unit to 7.1 in approximately 3.5 hours. The pH of the drained stream from the species separation compartment 44 was significantly alkaline, at approximately 12.3.

Hydrogen evolved in the separation compartment 44 was vented into the main flow (flow-compartment 42 of cell 25) and returned to the tank. Despite constant drainage and gas evolution, the liquid level within the chemical species separation compartment 44 was always maintained not lower than the lower liquid control level (inner inverted weir 62), and the inner electrode 40 always remained submerged.

In the second experiment, cell 25 was used in the control of pH in a large, outdoor saltwater swimming pool. The electric pH controller 25 was installed poolside, above the water level of an outdoor domestic pool of approximately 45,000 litre capacity, with a pump, filter and conventional saltwater chlorination unit installed in a conventional manner, as per FIG. 2. The pool surface was comprised of tiles and grout, which when unmanaged buffers the pool to a high pH of around 8.2. As noted, the pH controller 25 was not incorporated in the main pumped pool loop, but operated in a standalone mode with its own small pump, similar to the lay-out in FIG. 2. Water was pumped from the pool, up through the pH controller, and returned to the pool via a hose. An electric potential was applied to the electrodes, such that the electrode 40 within species separation compartment 44 functioned as the cathode of the cell 25. The separation compartment 44 was connected to a small manual valve in order to effect draining at a constant slow rate. Thee pH and oxidation reduction potential (ORP) was monitored using sensors installed in the pool loop in conventional manner. The ORP is a direct measurement of the disinfection action in the pool, and is a function primarily of the concentration of hypochlorous acid, hypochlorite ion, and pH in the pool. A conventional saltwater chlorination system operated on a timed cycle through part of the experiment.

The rate flow of pool water through the pH control cell 75 was set to 18 litres per minute. The rate of drainage of the separation compartment 44 was set to 0.18 ml per second (10.8 ml per minute). A potential of 14 V was applied to the electrodes, which produced a current of 8.0 amps.

The electrodes were first ‘turned on’ at 11.00 am on the 30^{th} of April 2014 and then turned off at 11.30 pm on the 3^{rd} of May 2014. The pH control cell thus ran continuously at 8 amps for 3.5 days (84.5 hours).

The pool chlorinator cell ran on a schedule from 10:15 pm to 7:45 am overnight and from 12:15 pm to 1:45 pm during the day, each day. This schedule was in operation when the pH controller was turned on. The chlorinator was turned off at 11:00 am on the 2^{nd} of May and did not run thereafter.

FIG. 4 shows the pH and ORP of the pool from the of April to the 10^{th} of May 2014, ie during a period prior to, during and after operation of the control cell. The vertical axis is the pH multiplied by and the ORP value is in millivolts.

Prior to turning on the pH control cell 25, switched to act as an acid species generator, the pool pH oscillated between constant bounds of about 8.2 and 7.8. This oscillation is due to the daily cycle of production of hypochlorous acid overnight by the chlorinator, which drives the pH up, and the destruction of hypochlorous acid during the day by sunlight, which drives the pH down. The cycling in the ORP trace is also due to this effect. The low spikes, in the pH curve are an artefact of the main pool pump cycling off, leaving stagnant pool water in contact with the sensors. The sensors do not truly represent the state of the pool at these times.

On April 25^{th}, 500 ml of concentrated hydrochloric acid was added manually to the pool, which led to a drop of the pH to about 7.4. The pool then recovered over the next for days to its natural value. This pool therefore required addition of approximately 500 ml per four days to maintain pH in a range suitable for adequate disinfection, in the absence of other means of pH control.

The electric pH controller was turned on at 11:00 am on the 30^{th} of April. The pH in the pool immediately began to drop. The pH dropped from a high of about 8.2 to a low of about 7.2 over the course of 3.5 days. The pH controller was turned off on May 3, and the pH began to recover, ie drift towards the ‘natural’ more basic side present in pools of the type controlled the experiment. This demonstrates effective control of the pool by the electric pH control cell in accordance with one of the aspects of the presently disclosed embodiment.

The ORP increased to very high levels after the pH controller was turned on. This was due in part to additional production of chlorine by the pH cell (which was acting as an acid generator), but in the main due to reduced pH. As the pH drops, pool chlorine present as hypochlorite ion converts to hypochlorous acid, which increases the ORP, and the disinfection action within the pool.

The rate of increase of pH after turning off the pH controller is slower than after the manual addition of acid, because of the high loading of chlorine in the pool. As hypochlorous acid and hypochlorite ion are destroyed by sunlight or reaction with organic molecules, they constitute a source of H⁺ ions. The residual chlorine therefore provides some pH buffering to the pool system. This also stabilizes the ORP level for some days, as the effect on the ORP of the loss of active chlorine is compensated for by the concomitant production of H⁺ ions. The use of the pH controller is there fore particularly efficacious in setting up a pool condition that can hold the ORP at a level sufficient for adequate disinfection over an extended time without any interaction with the pool, whether by manual addition of chemicals such as acid or chlorine compounds, or electrical chlorination, or electrical pH control. It will be appreciated that the different aspects of the presently disclosed embodiment, in particular the specific lay out of the pH control cell 25 may be varied, as long as the above mentioned functionality is implemented, i.e. temporarily separating two volumes of saltwater which enter the cell, during the electrolysis process, and removing a concentrated catholyte (base chemical species) for lowering pH or removal of concentrated anolyte (acidic chemical species) for increasing pH, from the stream of water being returned from the cell to the pool.

What is claimed is:

1. A system for electric pH control of saltwater swimming pools, comprising:
a pump-assisted circuit for circulating saltwater to and from a swimming pool;
means for determining the pH of the saltwater, preferably a pH sensor;
a pH control cell with an inlet and an outlet connected to the pump-assisted circuit for receiving and discharging saltwater from/to the pool, respectively, the pH control cell having at least one pair of electrodes arranged for electrolytically creating an alkaline and an acidic chemical species from saltwater flowing through the cell, the cell comprising a water flow-through compartment in which one of the electrodes is located and a species separation compartment arranged for receiving saltwater from the pump-assisted circuit and in which the other of the electrodes is located, the compartments being separated by a separator structure which is permeable to cation and anion transfer and either highly restrictive to or blocking of electrolyte flow between both compartments;
a drainage structure, preferably including valve means, arranged for selectively draining liquid from the species separation compartment in controlled manner to waste; and
a controller functionally operative to
compare the pH determined or sensed with a desired pH value, apply an electric potential across the electrodes of the cell and control one or both of the potential and electric current supplied to the electrodes as a function of the pH comparison and
regulate drainage of an alkaline or acidic species which has been electrolytically generated within the species separation compartment from pool water flowing through the flow-through compartment as a function of positive or negative potential being applied to the electrode in the species separation compartment.

2. Swimming pool control cell, comprising:
a water flow-through compartment within a housing and which can be coupled into a pump-assisted circuit for circulating saltwater between a swimming pool and the cell;
a species separation compartment at or within the housing, arranged to receive saltwater from the swimming pool and having a drainage structure arranged for selectively draining liquid from the species separation compartment in controlled manner, preferably to waste through a controlled valve;
a separator structure between the compartments which permeable to cation and anion transfer and which can be either blocking of or highly restrictive to bulk electrolyte flow between both compartments;
at least one pair of electrodes arranged for creating an alkaline and an acidic chemical species from saltwater flowing through the cell, one of the electrodes located in the water flow-through compartment and the other located in the species separation compartment, the electrodes being connectable to a DC electricity source for effecting saltwater electrolysis; and
a controller operative on the electrode pair and having a controller functionally devised for
comparing a sensed pH of pool saltwater with a desired pH value,
controlling one or both of electric potential across the electrodes of the cell and electric current supplied to the electrodes as a function of the pH comparison and
regulating drainage of an alkaline or acidic species produced by electrolysis from saltwater within the separation compartment from pool water flowing through the flow-through compartment as a function of positive or negative potential being applied to the electrode in the species separation compartment.

3. The cell of claim 2, wherein the species separation compartment is located within the housing in the flow through compartment.

4. The cell of claim 2, wherein the species separation compartment is devised to receive saltwater via the flow-through compartment, preferably via a lock structure or mechanism operating between both compartments, more preferably a gas lock.

5. The cell of claim 2, wherein the species separation compartment has at least one fill-level control for controlling the level of liquid in the compartment and maintaining the electrode in the species separation chamber submerged in water during operation of the cell.

6. The cell of claim 2, wherein the species separation compartment has a gas venting port for venting gas, preferably into the flow-though compartment.

7. The cell of claim 6, wherein the species separation compartment comprises at least one gas head-space arranged to vent into the flow-through compartment and provide a gas lock between the compartments.

8. The cell of claim wherein the fill-level control and the gas head-space structure comprise two, vertically spaced apart inverted weir structures in a wall separating the species separation from the flow-through compartments of the cell.

9. The cell of claim 8, wherein an upper and a lower of the two inverted weir structure are located between the species separation and flow-through compartments at a location which allows backflow of saltwater from the flow-through compartment into the species separation compartment during draining of the latter via the valve means and to maintain the electrode within the species separation compartment submerged.

10. The cell of claim 8, wherein the weir structures comprise at least one, preferably rectangular slot in a wall separating an interior of the species separation compartment from the flow through compartment.

11. The cell of claim 2, wherein the cell housing is tubular in configuration and fully surrounds an inner casing defining the species separation compartment between water flow inlet and outlet couplings of the cell.

12. The cell of claim 2, wherein the cell housing is box-like configuration and comprises an inner chamber separated into two discrete volumes by a partition wall thereby defining the flow through compartment and the species separation compartment at opposite sides of the housing the partition wall comprising a through hole in which the separator structure is received and further comprising upper and lower inverted weir structures at locations in the partition wall which allows backflow of saltwater from the flow-through compartment into the species separation compartment during draining of the latter via the valve means and otherwise to maintain the electrode within the species separation compartment submerged.

13. The system of claim 1, wherein the pH control cell in accordance with claim 2.

14. The system of claim 13, wherein the controller is operative to apply a negative potential to the electrode within the species separation compartment sufficient to drive hydroxide ion (OH—) production from saltwater and an alkaline catholyte in the species separation compartment and an acidic anolyte from saltwater flowing in the flow-through compartment of the cell.

15. The system of claim 14, wherein the controller is operative to apply a positive potential to the electrode within the flow-through compartment sufficient to produce chlorine from saltwater within the flow-through compartment of the cell.

16. The system of claim 13, wherein the controller is operative to temporarily invert the polarity of the electrodes to a value sufficient for dissolving lime scale and alkaline fouling agents precipitated from saltwater in an alkaline environment, in particular at the negative electrode and the separator structure, during operation of the pH control cell.

17. The system of a claim 13, further comprising a valve-controlled draining line in communication with a lower end of the species separation compartment for effecting selective and controlled draining of liquid from the species separation compartment towards waste or a storage tank.

18. The system of claim 13, wherein a swimming pool saltwater supply line with controlled shut-off valve is connected to the species separation compartment of the pH control cell.

19. The system of claim 13, wherein the pump-assisted circulation circuit is a filtration recirculation circuit of a swimming pool installation.

20. The system of claim 13, wherein a saltwater chlorination cell is arranged downstream of the pH control cell.

21. A method for electric pH control of saltwater swimming pools, comprising:
determining the pH of saltwater in a swimming pool or flowing through a swimming pool water recirculation circuit;
circulating saltwater to and from the swimming pool past a saltwater electrolysis cell, the cell arranged for generating alkaline and acidic chemical species from saltwater using at least one pair of cell electrodes, the cell comprising a flow-through compartment in communication with the pool water recirculation circuit and in which one of the electrodes is located, and a species separation compartment in which the other of the electrodes is located and which is arranged to receive saltwater from the recirculation circuit, the cell compartments being separated by a separator structure which is permeable to cation and anion transfer and is otherwise restrictive to bulk electrolyte flow between both compartments;
selectively applying an electric potential difference across the electrodes and controlling one or both of voltage across and electric current supplied to the electrodes as a function of the pH determined and a desired pH of the pool water to produce alkaline or acidic chemical species from the saltwater at the electrode in the species separation compartment while maintaining pool water flow in the flow-through compartment; and
selectively draining liquid containing the alkaline or acidic chemical species from the species separation compartment in controlled manner away from the pool water.

22. A method for electrolytic pH control and chlorination of saltwater swimming pools, comprising:
determining the pH and ORP (or chlorine) levels of saltwater in a swimming pool;
circulating saltwater to and from the swimming pool past a saltwater electrolysis cell, the cell arranged for generating chlorine and alkaline and acidic chemical species from saltwater using at least one pair of cell electrodes, the cell comprising a flow-through compartment in communication with the pool water recirculation circuit and in which one of the electrodes is located, and a species separation compartment in which the other of the electrodes is located and which is arranged to receive saltwater from the recirculation circuit, the cell compartments being separated by a separator structure which is permeable to cation and anion transfer and otherwise restrictive to bulk electrolyte flow between both compartments;
selectively applying an electric potential difference across the electrodes and controlling one or both of electric current supplied to the electrodes and applied voltage as a function of the determined pH and chlorine level and a desired pH and chlorine level in the pool water, whereby the electrode in the species separation compartment is negative relative to the electrode in the flow-through compartment so that chlorine and acidic chemical species are produced from the saltwater at the positive electrode and hydroxide is produced at the negative electrode in the species separation compartment; and
maintaining pool water flow in the flow-through compartment for delivering the chlorine and acidic chemical species produced during electrolysis into the pool water circulation circuit and selectively draining liquid containing the alkaline chemical species from the species separation compartment in controlled manner away from the pool water.

23. The method of claim 21, wherein determining the pH and/or chlorine levels in the saltwater involves use of electrochemical pH and ORP sensors upstream of the cell within the circulation circuit.

24. The method of claim 21, wherein hydrogen gas generated in the species separation compartment during operation of the electrolytic cell is vented into the water stream flowing through the flow-through compartment.

25. The method of claim 21, wherein circulation of saltwater to the cell is interrupted for a short period of time while maintaining the electrodes energized.

26. The method of claim 21, wherein the operating parameters are set such that liquid in the separation compartment is drained therefrom at a pH higher than 9 or lower than 6.

27. The method of claim 21, wherein the drainage rate of liquid from the separation compartment is selected at between 1 and 60 ml per minute over a predetermined time interval.
